(19) United States
(12) Patent Application Publication
(10) Pub. No.: US 2008/0288413 A1
(43) Pub. Date: Nov. 20, 2008

(54) Method for the Automatic Generation and Processing of an Invoice Document

(76) Inventor: Jan Weber, Starnberg (DE)

Correspondence Address: MARGER JOHNSON & MCCOLLOM, P.C., 210 SW MORRISON STREET, SUITE 400, PORTLAND, OR, 97204, US

(21) Appl. No.: 11/916,226

(22) PCT Filed: Jun. 2, 2006
(86) PCT No.: PCT/EP2006/062882

§ 371 Date: Jun. 13, 2008

(30) Foreign Application Priority Data
Jun. 2, 2005 (EP) 05104813.0

(51) Int. Cl. G06Q 20/00; G06Q 10/00; G06Q 30/00; G06Q 40/00

(52) U.S. Cl. 705/71; 705/34; 705/35; 705/40

(57) ABSTRACT

The invention relates to a method for automated invoice generation and settlement from a payer (50) to a payee (20), comprising the steps of recording the invoice data necessary for carrying out the payment process for the invoice settlement, generation and printing of an invoice document, (10, 18), application of a memory element (12) to the invoice document, sending the invoice document (10, 18) with memory element (12) to the payer (50), read out of the invoice data from the memory element (12) by means of a reading device (52), transmission of the read-out invoice data to an automatic payment transfer system (30) and carrying out the payment process to the payee (20), based on the read-out invoice data. Said method permits a simple and economical transmission of the data necessary for an automated execution of an invoice settlement together with an invoice document.

### BACKGROUND OF THE INVENTION

Manually inputting printed or written information to computers or other appropriate data processing devices requires effort which incurs costs for businesses and involves uninteresting work from a personal point of view. There is also a risk of errors during the transfer. Furthermore, details contained in transfer orders, such as account numbers and numbers for identifying the bank and optionally numbers for reference purposes must not contain the slightest error because otherwise, the entire transaction will not be able to proceed.

As a result of the increasingly widespread use of online banking, more and more business and private bank customers manually input the contents of transfer orders or data contained on invoices into the computer, resulting in the disadvantages described above. As a rule, therefore, transfers have to be entered individually and hence is time-consuming. Other commonly used and, to a certain extent, more readily available devices, such as mobile telephones and PDAs, can be used to organise transfers, but only at the expense of comfort because inputting data by means of the small key pad is relatively awkward.

This also results in disadvantages for the beneficiary of the payment because transfers may be delayed for reasons of convenience or because batches are set up containing a larger number of invoices with a view to improving working practices.

In the business and private sector, there is a need to compare documents such as tenders, quotations, order letters, order confirmations, contracts and invoices. The particular reason for this is to check the amounts and associated services. Under certain circumstances, it may also be necessary to check the general terms and conditions of business again. This comparison requires a lot of work and can lead to mistakes. Particularly in companies, it can lead to extra work personal work and costs.

Transfer orders, which are sent to banks in paper format, have to be input by appropriate means on an automated basis for further electronic data processing. The process of inputting data on an automated basis which may have already have been printed onto the transfer orders by the beneficiary of the transfer and the data of the remitter, in many cases completed by hand, is susceptible to errors. Even with a relatively low error rate, checking and correcting faulty data requires a considerable amount of extra work.

Naturally, a known approach is to send invoice and similar data by remote data transmission, for example by E-mail, Internet or Intranet, from an invoice issuer to an invoice recipient or from a beneficiary of a payment to a debtor. However, for many reasons, for example requirements imposed by financial authorities with a view to providing evidence of value added tax, it is necessary to send at least one original invoice document in printed paper format to the recipient of the invoice. Additionally transmitting the data needed for settling the invoice, i.e. implementing the payment transfer, such as customer number, invoice number, account details, sort codes, IBAN, etc. of the beneficiary of the payment, via a remote data transmission in addition to sending the printed invoice document therefore represents extra work. The recipient of the invoice then has the difficulty of matching the printed invoice document correctly with the electronically transmitted invoice data.

Accordingly, the technical objective underlying the invention is to propose a method of generating and settling an invoice from a debtor to a beneficiary of a payment, which permits automated processing by both the issuer of the invoice and the debtor, reducing extra work at both ends as well as the susceptibility to errors.

### SUMMARY OF THE INVENTION

This objective is achieved on the basis of a method of issuing and processing an invoice document on an automated basis for implementing a payment transaction from a debtor to a beneficiary of the payment, comprising steps which involve retrieving the invoice data needed to implement the payment transaction in order to settle the invoice, generating and printing an invoice document, applying a memory element to the invoice document, storing the invoice data in the memory element, despatching the invoice document with memory element to the debtor, reading out the invoice data from the memory element by means of a reading device, transferring the read invoice data to an automated payment transfer system and implementing the payment transaction to the beneficiary of the payment based on the read invoice data.

The method proposed by the invention enables the issuer of the invoice, in one process, to issue a printed invoice document and simultaneously generate and send invoice data relating to this invoice document which can be digitally processed. The invoice recipient/debtor may check the invoice document if necessary, detach it for the book-keeping department and read out the data needed for implementing the payment transaction in a simple manner with an appropriate reading device. The work required both on the part of the invoice issuer/beneficiary of the payment and the invoice recipient/debtor can be reduced. Furthermore, susceptibility to errors is reduced.

The invention also proposes a method of generating an invoice document on an automated basis comprising the steps of retrieving the invoice data needed to implement a payment transaction in order to settle the invoice, generating and printing out an invoice document containing the invoice data in printed format, applying a memory element to the invoice document and storing the invoice data in the memory element.

In one variant of the invention, the invoice data stored on the memory element additionally includes date information relating to the issuing of the invoice and/or the payment transaction, for example the date on which the invoice was issued, a defined date by which payment is due or time-related settlement conditions such as discounts. This facilitates and automates compliance with and monitoring of payment deadlines and objectives as well as associated discount terms. Furthermore, the payment transaction may be implemented as a function of the read date information.

For checking purposes, the date information may be compared with an external time measuring system such as a clock integrated in the computer or reading-in device.

Before implementing the payment transaction, a data comparison may also be run with an external server computer in order to identify the invoice document and/or to retrieve additional information relating to the payment transaction.

The invention further proposes an invoice document, which contains invoice data in printed format needed for implementing a payment transaction in order to settle the invoice and which has a memory element applied to the invoice document on which the invoice data is stored in a format which can be digitally processed.

The data contained in the memory element may be read out by means of an appropriate reading device and input and further processed by means of a computer, a computer system or some other digital terminal device such as a telephone, mobile telephone or a PDA. The payment transaction may be implemented by an appropriate transaction system such as an online banking system, a telephone banking system or similar.

Furthermore, the debtor may write an authorisation code and/or a separate item of information about the bank account onto the existing memory element or onto a second memory element added to the first memory element using an appropriate writing device, or a memory element containing his data prepared by the bank may be added to the invoice. The invoice or alternatively only the memory element can then be forwarded to a bank, which then implements the payment transaction.

It may be preferable if the memory element is a so-called RFID (Radio Frequency Identification) Chip, to which data can be permanently written by means of a data writing device of a type known per se. This data may be read out again by radio without contact. This being the case, an RFID chip may have its own power supply or may operate solely with the power of the read-out beam. It may be a write-protected read-only memory or a re-writeable memory. Other memory systems which have a slim thickness and can be easily applied to an invoice document may naturally also be used within the context of the invention.

The memory element may be adhered to the invoice document or laminated into it. In order to facilitate processing a stack of invoices, the position of the memory elements is preferably varied on consecutive invoice documents during the process of applying the memory elements.

By means of perforation or similar, a tear-off region may be provided on the invoice document for the memory element, which makes it easier simply to remove the memory element in readiness for despatch.

In order to increase data security, the data stored in the memory element may be protected by means of a data encryption key or a password. This being the case, the password may be printed on the invoice document, thereby making it necessary to open an envelope in which the invoice document was posted in order to read out the data.

It may be preferable to use a computer system of the debtor, which compares the data read out from the memory element of the invoice document with associated stored data, which was collated beforehand from quotations, tenders, order letters, order confirmations, contracts, general terms and conditions of business or similar.

The invoice document may also be a so-called transfer order, for example, on which the information of the payment beneficiary needed to implement the transfer has already been pre-printed.

### BRIEF DESCRIPTION OF THE DRAWINGS

The invention will be explained in more detail below with reference to an example of an embodiment illustrated in the appended drawings.

FIG. 1 shows a first example of a hardware configuration for implementing the method proposed by the invention.

FIG. 2 shows a second example of a hardware configuration for implementing the method proposed by the invention.

FIG. 3 is a flow chart, schematically illustrating the method steps of an example of an embodiment of the method proposed by the invention for producing an invoice document.

FIG. 4 is a flow chart, schematically illustrating the method steps of an example of an embodiment of a method proposed by the invention.

FIG. 5 is a flow chart, schematically illustrating the method steps of another example of an embodiment of a method proposed by the invention.

FIG. 6 schematically illustrates the method sequence of an example of an embodiment of the method proposed by the invention.

FIG. 7 schematically illustrates an example of an embodiment of an invoice document proposed by the invention.

FIG. 8 schematically illustrates a step of generating an invoice document based on one example of an embodiment of the invention.

FIG. 9 schematically illustrates the step of reading out and processing data from an invoice document proposed by the invention provided with a memory element.

FIG. 10 schematically illustrates the step of further processing the data at a bank, based on one example of an embodiment of the invention.

FIG. 11 illustrates another example of a hardware configuration for implementing the method proposed by the invention.

FIG. 12 is a flow chart, schematically illustrating the method steps of another example of an embodiment of the method proposed by the invention.

### DETAILED DESCRIPTION OF EXAMPLES OF EMBODIMENTS

For the purpose of the invention, printed invoices or transfer orders/payment slips are provided with an electric circuit, an RFID (Radio Frequency Identification) chip. The relevant data, such as the account details of the payment beneficiary, the currency, the amount and the intended purpose in particular and optionally other information about the invoice such as the description of the service provided/to be provided, is stored in the RFID chip. Computers, PDAs, telephone land lines and/or mobile telephones are equipped with reading units which are able to read out the information in the RFID chip for further electronic processing. The data is transmitted by radio. The format of the transmitted data should preferably be standardised. The data is further processed in the computer, mobile telephone or PDA in an appropriate manner, for example in transfer masks for online banking or in data processing systems of companies.

If necessary, it should be possible to process a stack of several invoices and/or payment slips. To this end, where necessary, the RFID chips should be positioned at varying points of the invoices to prevent them from interfering with one another. Invoice data may be compared with data contained in RFID chips applied to quotations, order letters and order confirmations in the same way. Transfer orders forwarded to banks in paper format may be input to data processing systems of the banks by means of the data stored in the RFID chips. The transfer orders may be completed by data pertaining to the remitter, likewise by means of an RFID chip, which the remitter applies to the transfer order.

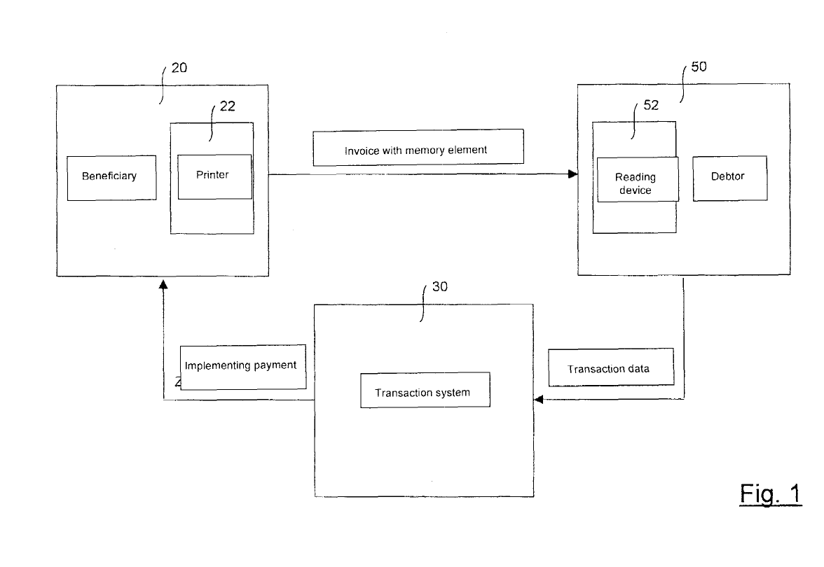

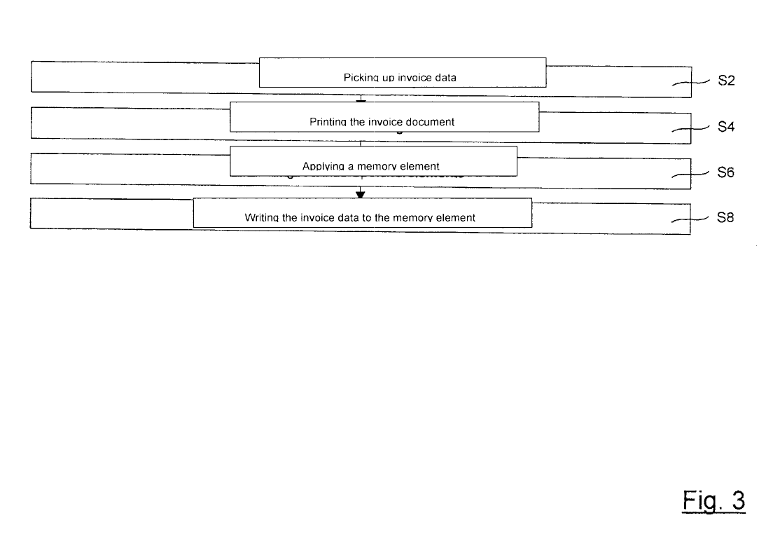

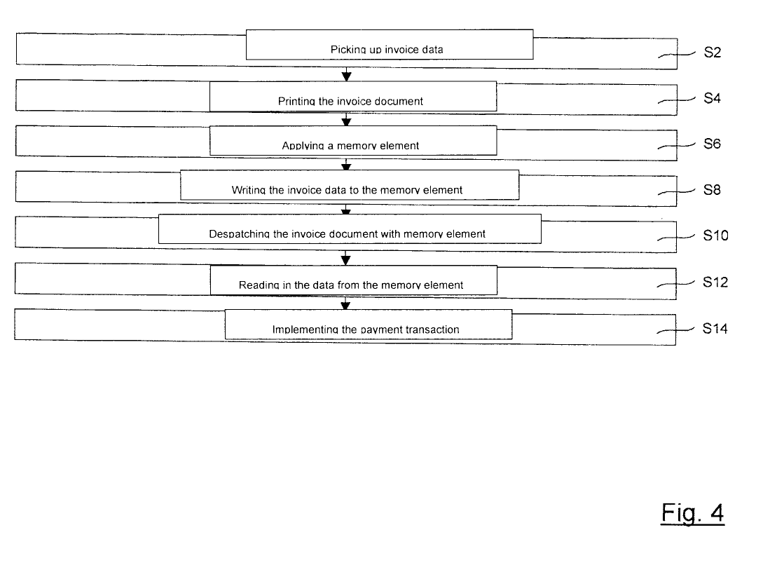

FIG. 1 provides a schematic illustration of a first example of a hardware configuration for implementing the invention. FIG. 3 is a flow chart, schematically illustrating the method steps of an example of an embodiment of the method proposed by the invention for generating an invoice document and FIG. 4 is a flow chart of a first example of an embodiment of the method proposed by the invention for generating and settling invoices based on the configuration illustrated in FIG. 1.

In step S2 in FIGS. 3 and 4, the computer system 20 of a payment beneficiary retrieves the invoice data needed to generate an invoice, such as person and address of the invoice recipient, customer number, invoice number, beneficiary's account information, etc., and prints the invoice document out with the aid of a printer 22 or similar in a subsequent step S4. This may be an individual invoice document, an invoice form or alternatively an invoice with an attached transfer form. In a subsequent method step S6, a memory element, preferably an RFID chip, is attached to the invoice, by gluing, laminating or in some other way. In method step S8, the invoice data, i.e. the data needed to implement the payment transaction, is written to the memory element. Methods steps S4, S6 and S8 may also be run in a different sequence from that illustrated in the drawings or also in parallel with one another.

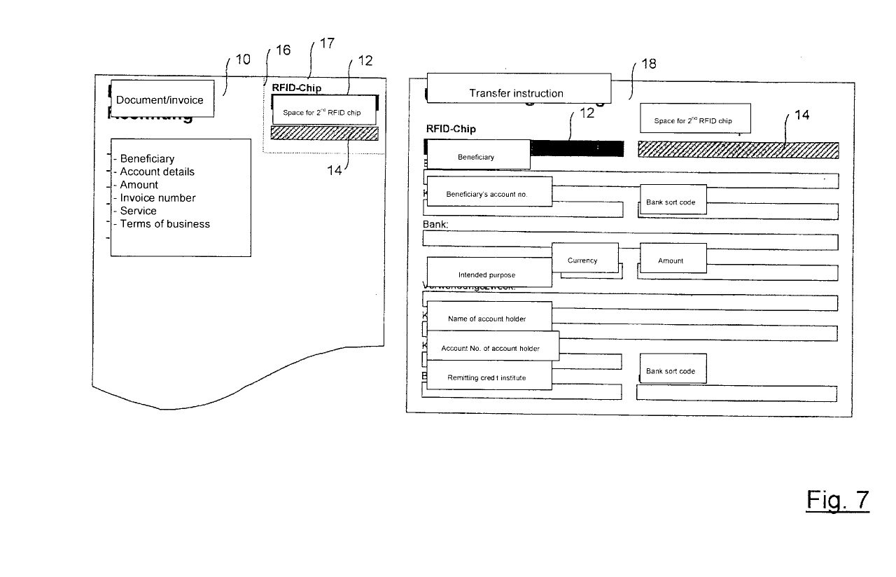

The invoice 10 with memory element 12 (see FIG. 7) is then despatched by post, courier, etc., to the invoice recipient or debtor (step S10). The latter has an appropriate reading device 52, by means of which the contents stored in the memory element 12 can be read out at step S12 in FIG. 4 and transferred to a computer system 50. This might be a book-keeping system of a company, a PC or alternatively an organiser or a mobile telephone. The read-in transaction data is transmitted to a transaction system 30 such as an online banking system or a telephone banking system, which implements the payment, i.e. debits the amount from the specific account of the debtor 50 and credits it to the payment beneficiary 20 (see step S14 in FIG. 4).

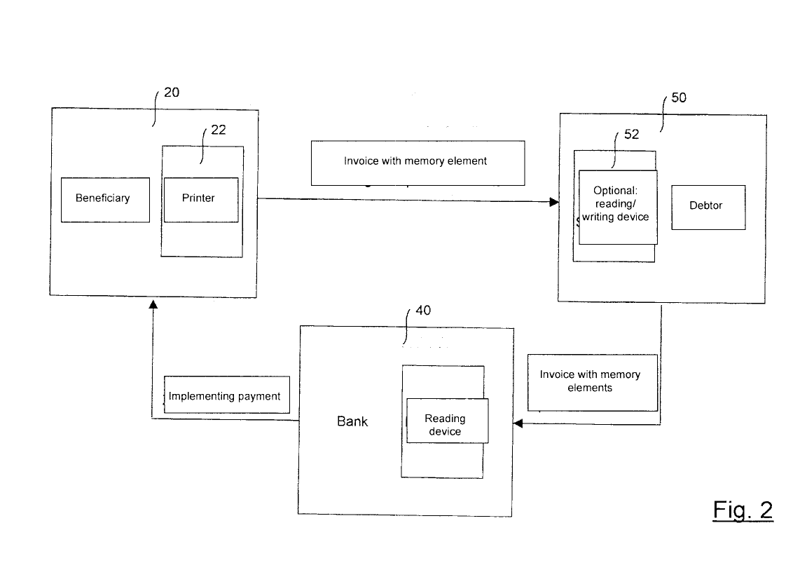

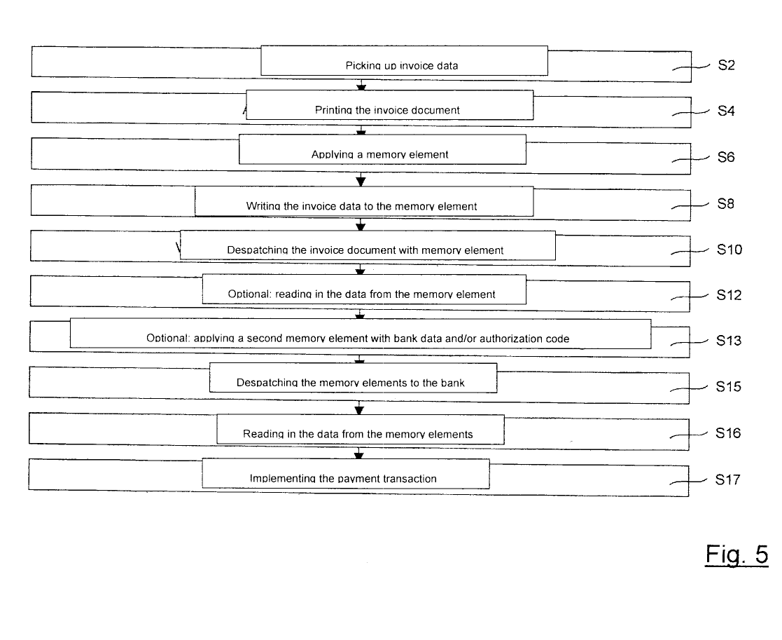

FIG. 2 illustrates a second example of a hardware configuration for implementing a second example of an embodiment of the method proposed by the invention, which is explained in FIG. 5.

The process of generating the invoice document corresponds to the embodiment explained as an example above in connection with FIG. 3 and will not be further explained. In step S12, the data is read in from the memory element 12 by means of a reading device 52. If the debtor decides that the invoice data is correct and the invoice should be settled, either an authorisation code may optionally be written to the existing memory element or a second memory element 14 may be attached to the invoice document 10, which contains an authorisation code and/or account information of the debtor (step S13 in FIG. 5). In method step S15, the invoice document with the two memory elements or the two memory elements alone are sent to a bank 40, where the data stored on the memory elements is read out in step S16 and the payment transaction is implemented in the final step S17.

Invoices are provided with RFID chips, on which all the relevant information is stored, such as the account details of the payment beneficiary, the currency, amount and the allocation details, for example, and optionally other items contained in the invoice such as a description of the service provided/to be provided. The RFID chip may be used in addition to or as a replacement for/alternative to an already partially completed transfer order. The data is transmitted to the RFID chip by radio when the invoice is generated.

In particular, the RFID chip comprises an antenna and a micro-chip in which the information is stored. The chip may be configured as a ROM in order to prevent subsequent editing. The RFID chip may be integrated in the paper or attached/adhered to the paper in the form of a label/smart label.

Computers, mobile telephones, PDAs or other devices suitable for electronic data processing are equipped with a reading device. It communicates with the RFID chip. If the RFID chip does not have its own power supply, the requisite energy is induced in the RFID chip by the reading device by means of radio waves. RFID chips are inactive as a rule. It is not until the power is supplied inductively or by a special activation signal that the data stored in the RFID chip is sent.

The reading device receives the data and directs it to the computer unit/CPU of the computer, mobile telephone or PDA. The data may be encrypted and/or standardised. The data is further processed in the computer or similar device. For example, it may be transferred to the transfer mask for online banking and displayed there. This may be done by initiating an appropriate command, e.g. by clicking on a button in the transfer mask.

The data read out from the RFID chip may also be stored and/or forwarded for further data processing, for example for book-keeping. In particular, data may be read in, stored and further processed with a view to comparing it with other documents. This applies in particular to documents such as tenders, quotations, order letters, order confirmations, contracts and invoices, but also general terms and conditions of business. This being the case, the processing of documents created during the course of a tender or contractual relationship can be simplified. In this situation, it is useful to define the data stored in the RFID chip as a relevant element of the contract in the event of variances from the printed text.

Standardising the data stored in the RFID chip facilitates further processing. For example, the data may always be stored in the same sequence, in always the same structures and/or with always the same names for the parameters/data fields. It is also possible to run a full document comparison.

Depending on the type of document, it may be of advantage to encrypt the data or some of the data stored on the RFID chip. Transfer orders are not encrypted as a rule, thereby ensuring problem-free processing by the recipient of the invoice. However, more detailed descriptions of the intended purpose and/or the service provided/to be provided may be encrypted, to prevent too detailed information from being sent to the bank, for example. In this situation, the sender and recipient of the documents/invoices must exchange, in a suitable manner, additional information needed for decryption purposes, for example passwords or data relating to the cryptography. This may be optionally stored in the software for reading in, reading out and processing the information, thereby enabling processing to be simplified.

To enable stacks of documents to be processed without errors, in other words reading in several invoices simultaneously, the RFID chips should be attached to different points of the document where necessary to rule out interference between the chips. This may be done on a random basis or using fixed parameters, for example as a function of the first letter of the payment beneficiary.

Transfer orders equipped with an RFID chip which are sent to the bank in paper format may also be transferred from the bank to their electronic data processing systems by reading the information from the RFID chip. This being the case, it may be practical to supply the remitter with RFID chips containing their bank details. The remitters then attach the second RFID chip containing their account data to the transfer instruction. Alternatively, writing units for remitters may be integrated in computers and similar, by means of which the remitters write the requisite data to the RFID chips.

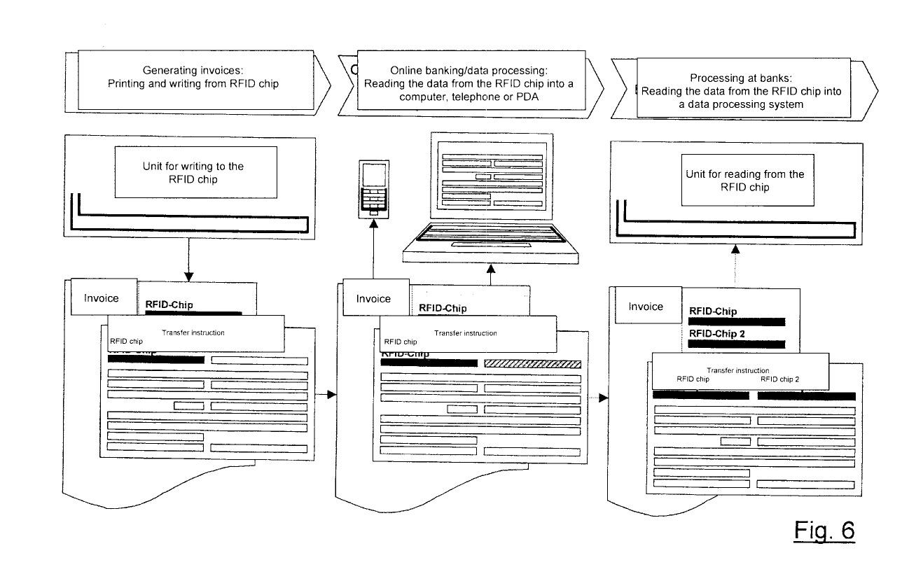

FIG. 6 provides a schematic illustration of the entire process involved in processing and data processing invoices and transfer orders. RFID chips are shown by black areas. Hatched areas indicate areas in which RFID chips can be added subsequently. Antennas of transmitter and receiver units are indicated by bolder lines to the corresponding devices and technical units. Arrows shown by broken lines indicate alternative sequences if the remitter does not use electronic data processing to implement the transfer.

The invention is based on a method specifically intended for storing data printed or written on invoices or transfer orders/payment slips and reading and processing it in a simple, efficient and reliable way in computers or other electronic devices suitable for data processing. The processing sequence will be described below with reference to the drawings.

As may be seen from FIG. 6, the sequence comprises three steps:
writing the data to an RFID chip attached to a document,
reading the data into a computer, a (mobile) telephone or a PDA and electronically processing it,
as an alternative to the second step, reading the data out from the RFID chip into a data processing system of banks.

RFID (Radio Frequency Identification) is a method of transmitting data without the need for contact or visual contact.

FIG. 7 illustrates the example based on a printed invoice 10 and a printed transfer order 18. The RFID chip 12 may be attached to either the invoice or the transfer order.

In the former case, the printed transfer order may optionally be dispensed with. A perforation 16 may be provided, which forms a tear-off region, thereby making it easier to remove the RFID chip from the invoice document 10, 18.

The RFID chip may be integrated in the paper of the documents or attached to it externally, for example by adhesive (smart label). In both cases, the RFID chip should be as thin and flexible as possible so that it can withstand the type of handling to which paper is subjected without being damaged. It is of advantage if the RFID chip is contained in paper of a standard thickness, in other words approximately 0.1 mm. In particular, this makes printing with standard printers easier.

The data written or printed on the documents is stored on the RFID chip, where relevant. The RFID chip is a transponder. As a rule, it comprises a micro-chip with electric circuits and a permanent memory, an antenna connected to the micro-chip and a support or housing. Active transponders additionally have their own power source, such as a battery or accumulator, for example. The circuits of the RFID chip are generally an analogue circuit for transmitting and receiving and a digital circuit. The memories may be written to several times, however, in the applications at issue here, this should not be a disadvantage as a rule because otherwise subsequent manipulations would be possible. Cryptography modules may also be integrated.

The information is read out and written by means of radio waves, at lower frequencies inductively via a near field and at higher frequencies electromagnetically via a far zone. For the application described here, so-called passive RFID chips which do not have their own power supply may be used because they are less expensive, smaller and lighter. The disadvantage of having a low range is of negligible importance when reading out documents into a computer or some other data processing device. Passive RFID chips receive their supply voltage by induction from the radio signals of the base station, in other words the units for writing and reading.

In particular, the RFID chip may be produced in the form of a label, a so-called smart label. This being the case, the transponder including the antenna is applied to a film which can be wound onto reels and processed like paper, laminated into paper layers or adhered to paper.

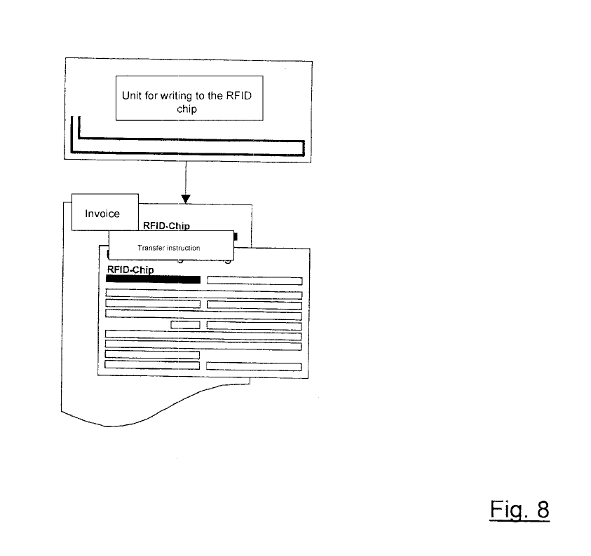

FIG. 8 illustrates the procedure by which the RFID chip is written. The unit for writing to the RFID chip transmits the data via radio/radio waves. The radio waves are also used to supply the RFID chip with the requisite power. In order to transmit the data, a transmitting antenna may be integrated in a printer, for example. This is an efficient way of enabling the text to be printed and the RFID chip to be written simultaneously, whereby the paper with the RFID chip is fed past the transmitter antenna during the course of the printing process.

With a view to reducing costs and obtaining a low weight and small dimensions, the RFID chip should be as small as possible. This can restrict the capacity of the memory. Small and inexpensive RFID chips may be used in particular by concentrating on the data that is relevant to a transfer. Furthermore, the data itself should be reduced to a minimum, optionally compressed and as far as possible standardised. For example, the data may be stored in a standardised sequence so that it is evident from the sequence which parameter must be correlated with the respective information. Alternatively, standardised names may be provided for the parameters for example.

Optionally, the data may be transmitted to the RFID chip partially or totally encrypted. This may be of advantage if the data or parts of the data should not be read by unauthorised persons. In this case, the requisite information such as passwords or cryptography data should be transmitted to the recipient separately.

In order to prevent unauthorised reading of RFID chips despatched by post, their range should be limited. If necessary, a password needed for reading from the RFID chip could be written on the printed document as a simple security measure, for example. This password is then only available when the letter is opened.

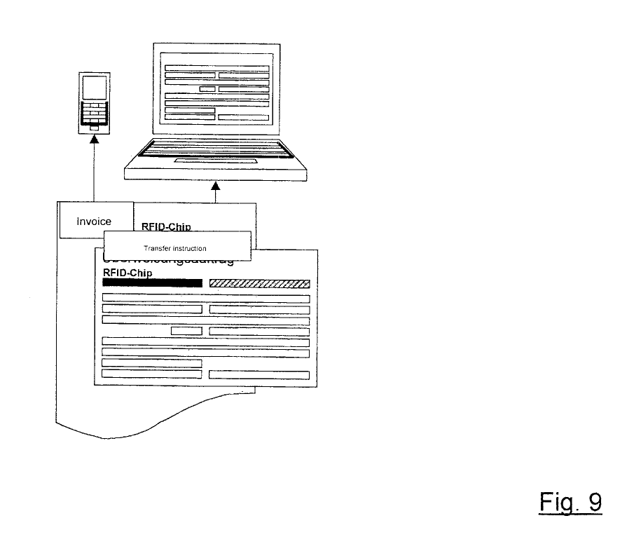

FIG. 9 illustrates further use of the document by the recipient, in particular electronic data processing. In the case of electronic data processing, the recipient uses an electric device, such as a computer, mobile telephone or PDA, for example, equipped with a transmitter-receiver unit (reader). The antenna of the transmitter-receiver unit may be disposed around the keyboard, for example.

A radio signal is sent to the RFID chip via the antenna in order to activate and optionally transmit the requisite power. The RFID chip likewise sends the stored information or parts of the information to the transmitter-receiver antenna of the electric data processing device by radio. One possible transmission option is that based on the Bluetooth standard, for example. Information is sent from the antenna to the computer unit/CPU of the computer, mobile telephone or PDA for further processing.

Appropriate hardware and/or software components may be used as a means of activating the RFID chip and controlling the data transmission and further data processing. In particular, the data may be transmitted to the device by a command initiated by the user of the data processing device and transferred to a mask for online banking or a data processing system for processing transfers, for example. The data may also be archived, further processed and compared with other data. A standardised data format facilitates processing.

A data comparison may be run using standard software for comparing documents or a special software application. It would be particularly practical to use a solution whereby the newly read-in data is compared with already stored data automatically under the control of software or when a button is depressed/clicked. To this end, data such as that pertaining to a quotation, order confirmation and invoice could contain a common ID code and optionally a code of the issuer of the invoice.

The software should also permit the processing of batches, in other words enable several RFID chips to be read out and the information further processed simultaneously, for example in several masks for the online transfer. Finally, the software should optionally be configured to support practical decryption of encrypted contents.

As already explained in the summary of the invention, it may be practical to position the RFID chips at different positions on the document, either randomly or on the basis of fixed rules, to rule out mutual interference and thus ensure batch processing without disruptions.

If the invoice recipient does not make payments by electronic means, he may alternatively forward the invoice with the RFID chip attached or the transfer order to the bank. He may also attach another RFID chip containing his own account details and his name to the invoice/transfer order, for example in the form of a label. Instead of the invoice, only a tear-off slip of the invoice to which the RFID chip or chips is or are attached may be forwarded to the bank as an alternative.

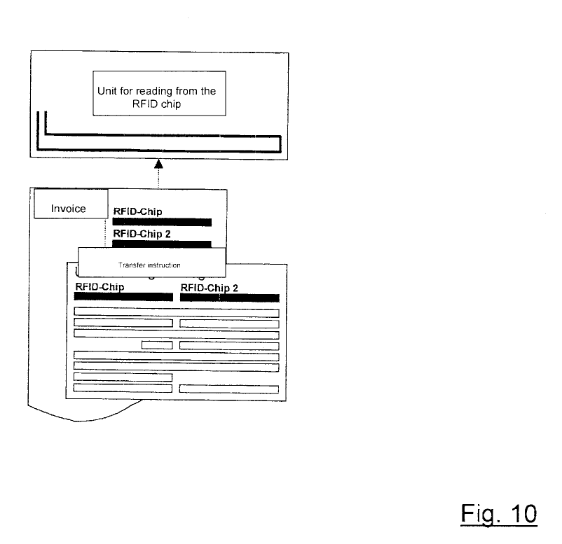

FIG. 10 illustrates the sequence of processing transfer instructions at banks. The data is read by means of a transmitter-receiver unit from the RFID chip containing the data of the payment beneficiary and optionally from a second RFID chip containing the data of the remitter and fed into the data processing system of the relevant bank. The same technical conditions apply as those described above in connection with the online transfer, especially the option of batch processing.

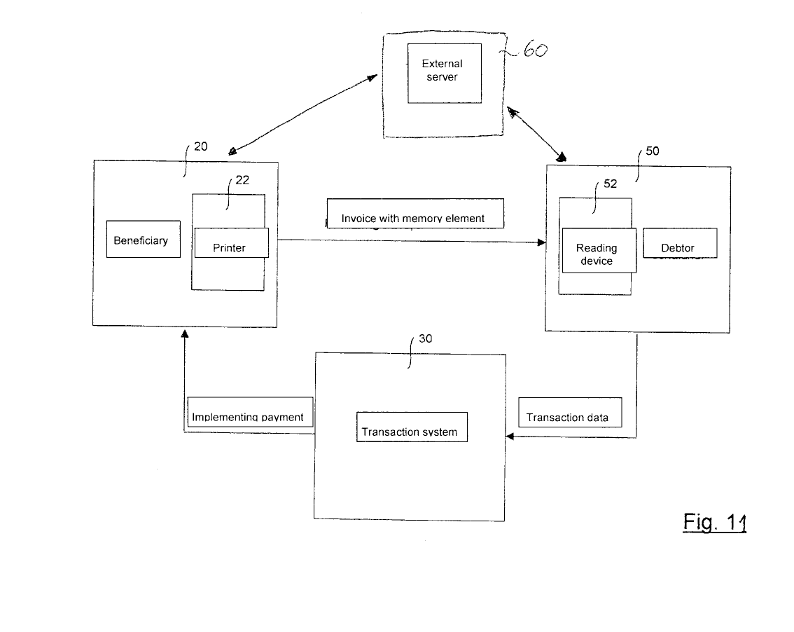

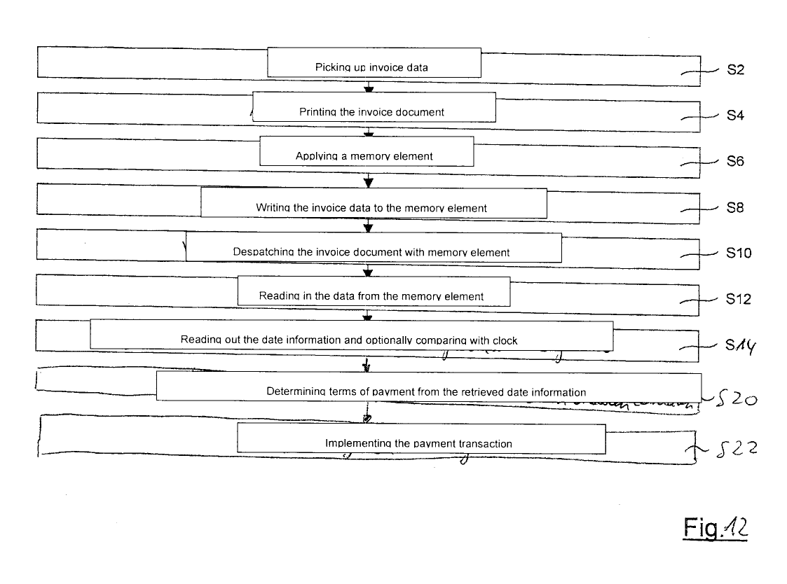

Another example of an embodiment of the invention will be explained with reference to FIGS. 11 and 12.

The memory element 12 attached to the invoice document 10 may additionally contain date information relating to the issue of the invoice and/or the terms of payment and/or date-related rules governing settlement of the invoice. These might be used to grant discounts, for example. In this respect, the invoice data may include the date the actual invoice was issued or a payment term or staggered payment periods (as a function of staggered discounts). For example, if the transfer is made within a period defined in the memory element, a reduced transfer amount is read out from the memory element 12 accordingly, based on rules likewise stored in the memory element, and read into the transfer mask.

This advantageous variant of the invention is schematically illustrated in the flow chart of FIG. 12. Method steps S2 to S12 correspond to those of FIG. 4. In step S14, the date information is read out and if necessary compared with a clock in the computer or similar for verification purposes. In the subsequent method step S20, the terms of payment are defined on the basis of the retrieved date information and the payment transaction is then run in method step S22 in accordance with the terms.

Other possible applications are situations in which invoices are settled late. In this situation, the transfer can be blocked, a higher amount inserted or a reminder message may appear, optionally incorporating reminder charges and interest. It may be practical to block a transfer if reminder charges are levied which would otherwise have to be repaid, for example because a late payment charge has become payable in the meantime.

Alternatively, an external server 60 may be used, as illustrated in FIG. 11, which identifies the invoice document on the basis of the data stored on the memory element 12 in order to take account of date-related terms of the invoice. An identification number may optionally be used for identification purposes. When reading out the invoice document 10 and implementing the transfer, the server 60 is contacted in order to exchange information.

This may be practical as a means of taking account of recently updated information, such as any reminders which might have been despatched, for example. The date of the transfer instruction may also be retrieved from the server. In particular, a bonus system rewarding timely payment or a discount account may also be managed on such a server.

Invoice data may also be held on the server in order to reduce the amount of data on the memory element on the invoice document, including what might be complex date-dependent terms of payment. In order to enable the above functions, in particular the granting of discounts, to be used in situations in which no data can or shall be read out from a memory element on the invoice document, an identification code may be provided on the invoice document, as a rule printed on it. This is manually entered during the course of the transfer transaction so that it can be processed in order to obtain the date-dependent terms of payment.

Compared with systems for reading written and printed transfer documents, reading the data from RFID chips obviates the need for complex mechanisms for handling paper. At the same time, the data transfer is less susceptible to errors. Ultimately, it is not even necessary to use standardised forms for the transfer orders. Instead, the customer can send an invoice or a copy of an invoice with the RFID chip containing the requisite data to the bank. Another option is to send a tear-off part of the invoice, on which the RFID chip or chips is or are disposed. This part may be prepared for tearing off by means of a perforation line 16, for example.

1. Method of generating and processing an invoice document for a payment transaction from a debtor (50) to a payment beneficiary (20) on an automated basis, comprising:
retrieving the invoice data needed to implement the payment transaction in order to settle the invoice,
generating and printing an invoice document (10, 18) containing the invoice data in printed format,
attaching a memory element (12) to the invoice document,
storing the invoice data needed to implement the payment transaction in order to settle the invoice in the memory element (12), this invoice data comprising at least one of the following invoice data: the payment beneficiary, account number, bank sort code, credit institution of the beneficiary, amount, currency, intended purpose and invoice number,
sending the invoice document (10, 18) with memory element (12) to the debtor (50).

2. Method as claimed in claim 1, further comprising the steps:
reading out the invoice data from the memory element (12) by means of a reading device (52) and
transmitting the read invoice data to an automated payment transfer system (30) and implementing the payment transaction to the beneficiary of the payment (20) on the basis of the read-out invoice data.

3. Method as claimed in claim 2, wherein the automated payment transfer system (30) is an online banking system.

4. Method as claimed in claim 2, wherein the automated payment transfer system (30) is a telephone banking system and the data stored on the memory element (12) is transmitted to the telephone banking system via a telecommunication link.

5. Method as claimed in claim 1, wherein an authorisation code is read onto the memory element (12) by the debtor (50) and the memory element is sent to a bank (40) to implement the payment transaction.

6. Method as claimed in claim 1, wherein the invoice document (10, 18) is provided with a second memory element (14) by the debtor (50), which contains an authorisation code and/or account information of the debtor, after which the two memory elements (12, 14) are sent to a bank (40) for implementing the payment transaction.

7. Method as claimed in claim 1, wherein the memory element (12) is an RFID chip, in particular a read-only RFID chip.

8. Method as claimed in claim 1, wherein the memory element (12) is attached to a transfer document.

9. Method as claimed in claim 1, wherein the memory element (12) is adhered to or laminated into the invoice document (10, 18).

10. Method as claimed in claim 1, wherein printed invoice documents (10, 18) are provided with memory elements (12) in different positions on the invoice document (10, 18).

11. Method as claimed in claim 1, wherein the invoice document (10, 18) has a tear-off region (17), to which the memory element is attached.

12. Method as claimed in claim 1, wherein the data stored on the memory element (12) is provided with a data encryption key and/or password protection.

13. Method as claimed in claim 12, wherein the password is contained in the printed invoice document (10, 18).

14. Method as claimed in claim 1, wherein the data stored on the memory element (12) has a standardised format, in particular a specific sequence of individual data elements.

15. Method as claimed in claim 1, further comprising: comparing the data read out from the memory elements with data retrieved from an order confirmation, a quotation and/or an order letter or similar existing in a computer system of the debtor (50).

16. Method as claimed in claim 1, wherein the invoice data stored on the memory element (12) additionally includes date information pertaining to the issue of the invoice and/or the terms of payment.

17. Method as claimed in claim 16, wherein the date information includes the date on which the invoice was issued.

18. Method as claimed in claim 16, wherein the date information includes a predefined payment period.

19. Method as claimed in claim 16, wherein the date information includes date-dependent terms of payment.

20. Method as claimed in claim 2, wherein the invoice data stored on the memory element (12) additionally includes date information pertaining to the issue of the invoice and/or the terms of payment and wherein the payment transaction is implemented as a function of the read-out date information.

21. Method as claimed in claim 20, further comprising comparing the date information with an external time measuring system.

22. Method as claimed in claim 20, wherein a date match is run with an external server computer (60) prior to implementing the payment transaction in order to identify the invoice document and/or retrieve additional information relating to the payment transaction.

23. Invoice document (10, 18) containing in printed format invoice data to implement a payment transaction in order to settle the invoice, the document comprising a memory element (12) attached to the invoice document (10, 18), on which the invoice data to implement the payment transaction in order to settle the invoice is stored in a format which can be digitally processed.

24. Invoice document as claimed in claim 23, wherein the invoice document (18) is a pre-printed form for a payment transaction.

25. Invoice document as claimed in claim 23, wherein the memory element (12) is an RFID chip.

26. Invoice document as claimed in claim 23, wherein the memory element (12) is adhered to the invoice document (10, 18) or laminated into it.

27. Invoice document as claimed in claim 23, further comprising a tear-off region (17) for removing the memory element (12).

28. Invoice document as claimed in claim 23, wherein the data stored in the memory element (12) is provided with a data encryption key.

29. Invoice document as claimed in claim 23, wherein the data stored on the memory element (12) is provided with password protection and the password is printed on the invoice document.

30. Invoice document as claimed in claim 23, wherein the invoice data stored on the memory element (12) additionally includes date information relating to the issue of the invoice and/or the terms of payment.

31. Invoice document as claimed in claim 30, wherein the date information includes the date on which the invoice was issued.

32. Invoice document as claimed in claim 30, wherein the date information includes a predefined payment period.

33. Invoice document as claimed in claim 30, wherein the date information includes date-related terms of payment.

34. Method of processing an invoice document on an automated basis for implementing a payment transaction from a debtor (50) to a beneficiary of the payment (20) comprising:
reading out, by means of a reading device (52), invoice data including date information pertaining to the issue of the invoice document and/or terms of payment from a memory element (12, 14) attached to the invoice document,
transmitting the read invoice data to an automated payment transfer system (30) and implementing the payment transaction to the beneficiary of the payment (20) on the basis of the read invoice data.

35. Method as claimed in claim 34, wherein the payment transaction is implemented as a function of the read date information.

36. Method as claimed in claim 35, further comprising comparing the date information with an external time measuring system.

37. Method as claimed in claim 35, wherein a data match is run with an external server computer (60) prior to implementing the payment transaction in order to identify the invoice document and/or retrieve additional information relating to the payment transaction.

38. Method as claimed in claim 34 further comprising: comparing the data read from the memory elements (12, 14) with data retrieved from an order confirmation, a quotation, general terms and conditions of business and/or an order letter or similar already existing in a computer system of the debtor (50).
